(19) United States
(12) Patent Application Publication
(10) Pub. No.: US 2008/0126520 A1
(43) Pub. Date: May 29, 2008

(54) Devices, systems and methods for network device conversion

(76) Inventors: Ryan Werber, Burnaby (CA); Matthew Wiggins, Blaine, WA (US); Peter Wood, Burnaby (CA)

Correspondence Address: PATTON BOGGS LLP, 8484 WESTPARK DRIVE, SUITE 900, MCLEAN, VA, 22102, US

(21) Appl. No.: 11/494,530

(22) Filed: Jul. 28, 2006

(51) Int. Cl. G06F 15/177

(52) U.S. Cl. 709/221

(57) ABSTRACT

The present invention is a converter for abstracting network devices away from manufacturer specific syntax and/or semantic capabilities by making the network devices configuration independent trough syntax and/or semantic conversion. An application program interface converts between input options and output options. The converter allows the user to choose from any input module to program end devices. The converter may function as a point and click option, a command line interface or any other interface. The present invention allows for the choice of output module based on requirements of a target network device.

### BACKGROUND OF THE INVENTION

a. Field of the Invention

The invention relates generally to devices, systems and methods for network device conversion, and, more particularly, to a network conversion that manages and converts capabilities, including, for example, the syntax and/or semantics of a network device.

b. Description of Related Art

Many standard syntaxes exist for programming network devices, and it is common that a preferred standard syntax for an input module is different than the standard syntax for the network devices. Proprietary systems with unique syntaxes are used by a majority of the largest companies in this field. Therefore, converters are needed to convert between distinct syntaxes to ensure proper communication. Existing interpreters are not capable of flexible any-to-any, many-to-many, one-to-many or one-to-one syntax conversions. Improved converters are needed for syntactically converting from a user selected syntax used in an input module to a different syntax used in a network device.

Many network devices may function interchangeably but have different methods or levels of functionality defined by semantics. Semantic conversion is generally a process of using semantic information to aid in the conversion of data in one representation or data model to another representation or data model. Semantic information is a component of an information model that uniquely identifies the content of an element. For example, semantic information on a network device may specify the path that packets will take across the device. The details of how a network device specifies the path varies between network devices, but each network device has a method of specifying the path. These methods are semantic information. Semantic conversion takes advantage of semantic information that associates meaning with individual data elements in one data model to create an equivalent meaning is a second data model. Semantic conversion is necessary to successful operation of network devices in situations where a first network device is replaced with a second network device of differing capabilities. Semantic conversion allows the second network device to replace and/or enhance the functionalities of the first network device by converting instructions from a first data model to a second data model. Existing semantic converters are not effective in efficiently converting semantic information between network devices. Converters are needed for semantically converting between disparate network device capabilities.

Needs exist for improved devices, systems and methods for abstracting network devices away from manufacturer specific syntax and/or semantic capabilities by making the network devices configuration independent through syntax and/or semantic conversion.

### SUMMARY OF THE INVENTION

Embodiments of the present invention solve the problems and/or overcome the drawbacks and disadvantages of the prior art by having a simple, easy to use application program interface that allows for abstracting network devices away from manufacturer specific syntax and/or semantic capabilities by making the network devices configuration independent through syntax and/or semantic conversion.

In particular, the invention accomplishes this by providing a converter that accepts any manufacturer's standard syntax and converts to any other manufacturer's standard syntax or converts semantically between network devices. Embodiments of the present invention may include a method of managing network devices independent of native functionality including identifying a target network device, loading a converter, identifying a native functionality of the target network device, receiving commands in an input module in a selected functionality, parsing and tokenizing the commands, generating an output module in the native functionality of the target network device, outputting the relevant parsed and tokenized commands into the output module, and sending the output module to the target network device for managing the target network device.

The method may also include receiving input about the target network device from the target network device during the step of identifying native functionality of the target network device, parsing and tokenizing the input about the target network device, and storing the parsed and tokenized input in a network device database.

The intermediate functionality may be distinct from the native functionality of the network device and the selected functionality.

The method may also include the step of outputting the stored commands to other output modules for other network devices in other native functionalities.

The method may also include the steps of storing the parsed and tokenized commands in an internal database m an intermediate functionality and accessing relevant parsed and tokenized commands in the internal database. The internal database is a configuration server.

The receiving commands may be performed via a graphical user interface or a command line interface.

End user information may be stored on a server.

Preferred embodiments of the present invention may also include an API converter having an identifier for identifying a target network device and native functionality of the target network device, a receiver for receiving input about the target network device from the target network device, an input module for receiving commands in a selected functionality, a conversion protocol for converting the commands from the selected functionality to an intermediate functionality and then to the native functionality of the target network device, one or more output modules for receiving the commands from the conversion protocol, and a transmitter for transmitting the one or more output modules to one or more target network devices.

The conversion protocol preferably parses, tokenizes and stores the commands in the intermediate functionality in an internal database.

Input about the target network device maybe stored in a network device database.

The API converter may be located on a server connected to a network or on the target network device connected to a network Embodiments of the present invention may also include a network device converter database having a first receiver for receiving commands from an input module in a native functionality of a first network device, an identifier for identifying the native functionality of the commands from the input module, a parser for parsing the commands into a selected functionality, a tokenizer for tokenizing the commands into a selected functionality, a storage device for storing the parsed and tokenized commands, a second receiver for receiving requests for the stored commands, and a transmitter for transmitting the stored commands to an output module in a native functionality of a second network device.

Additional features, advantages, and embodiments of the invention maybe set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE INVENTION

The accompanying drawings, which are included to provide a further understanding of the invention and are incorporated in and constitute a part of this specification, illustrate preferred embodiments of the invention and together with the detailed description serve to explain the principles of the invention. In the drawings:

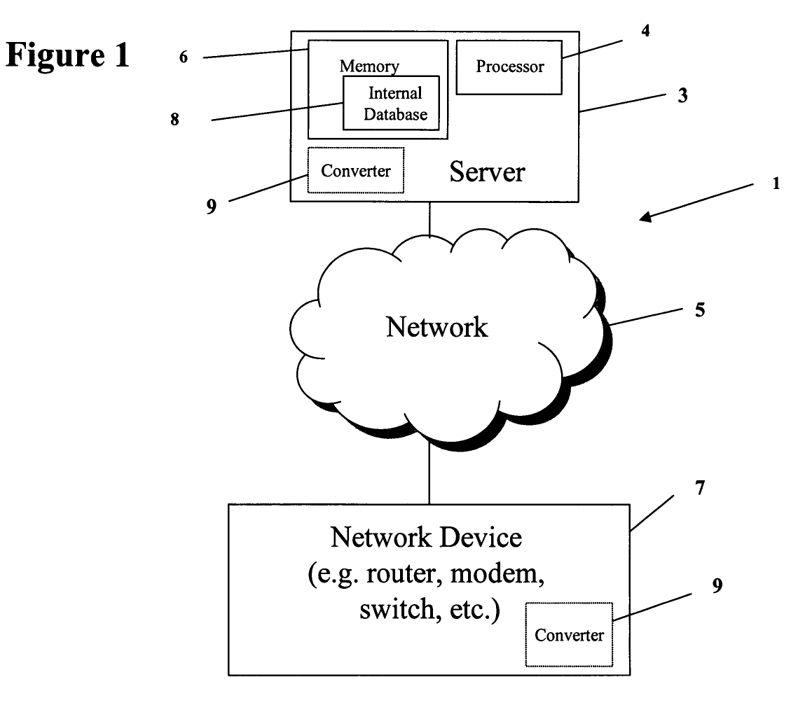

FIG. 1 is an embodiment of a schematic of a network device system using the converter of the present invention.

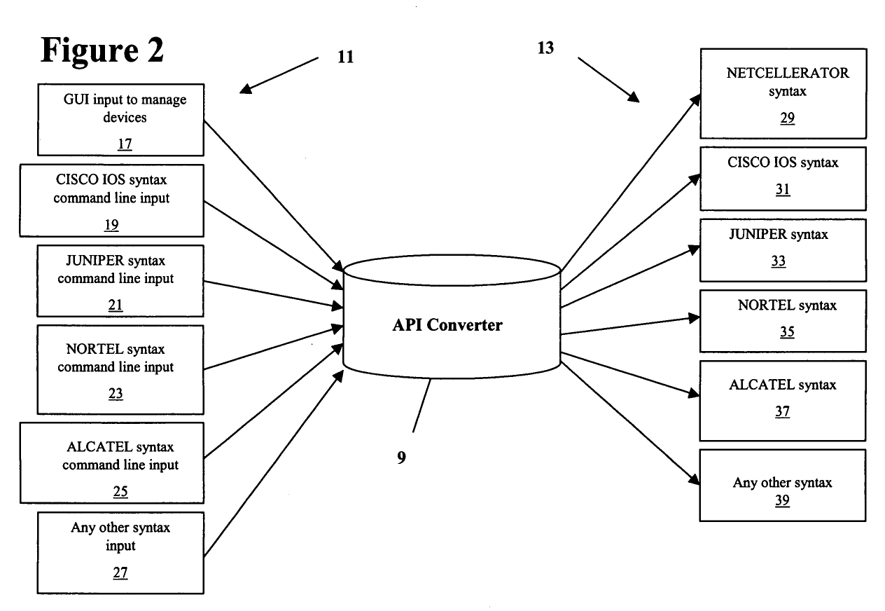

FIG. 2 is an embodiment of a schematic of input options and output options passed through an application program interface converter.

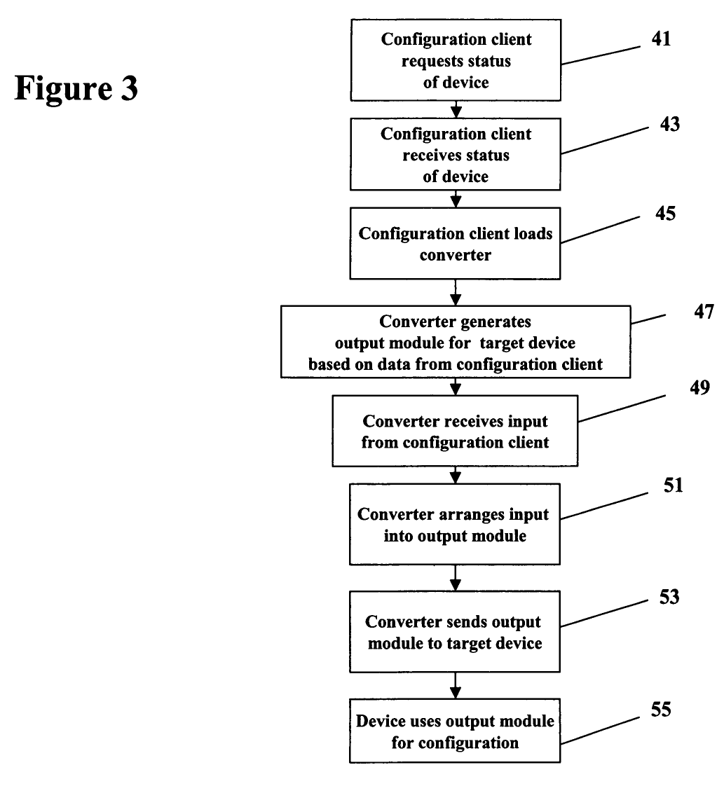

FIG. 3 is an overview flow diagram of an embodiment of the present invention.

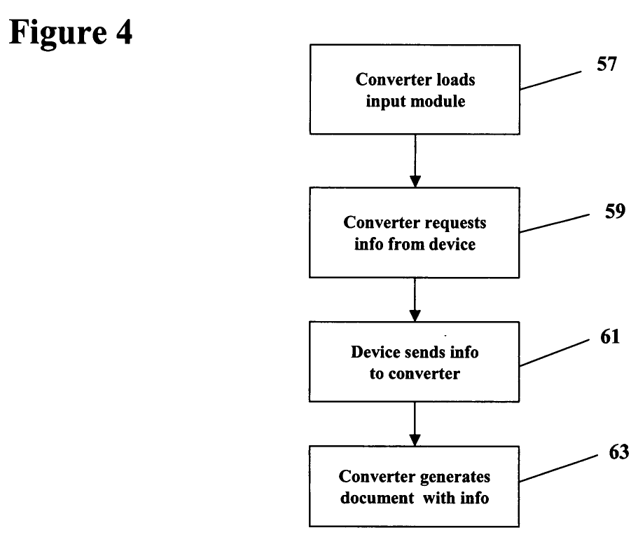

FIG. 4 shows a flow diagram of an embodiment of a configuration client's request for a current configuration of a target device.

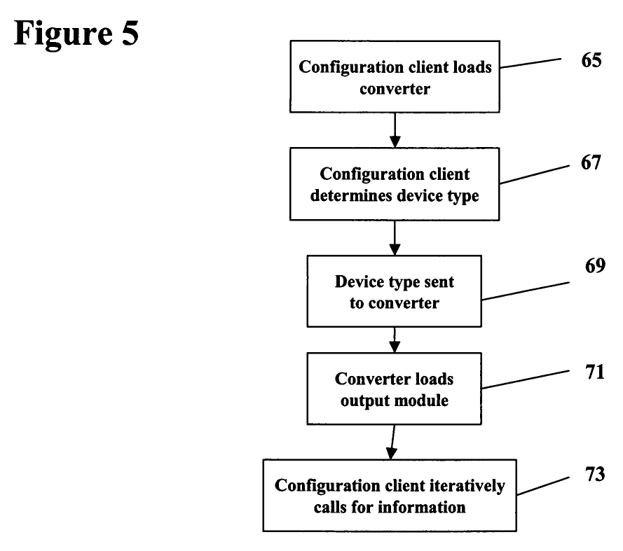

FIG. 5 shows a flow diagram of an embodiment of the configuration client using the converter application program interface to generate a converter's internal model of a configuration state.

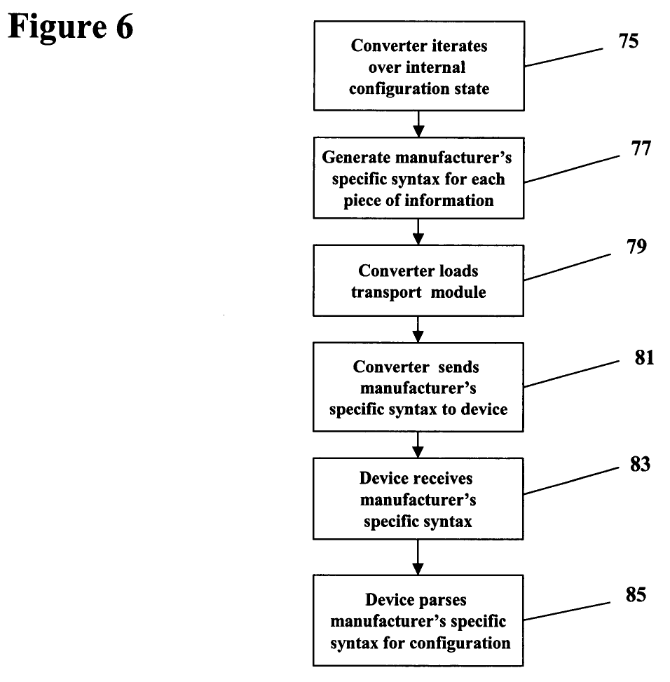

FIG. 6 shows a flow diagram of an embodiment for sending manufacture specific syntax and/or semantics to the target device to allow configuration of the target device.

### DETAILED DESCRIPTION OF THE PREFERRED EMBODIMENTS

Embodiments of the invention are generally directed to systems and methods for one-to-one, one-to-many, and any-to-any syntax and semantic conversions for network devices. Applicant's co-pending U.S. Ser. No. 11/438,849 titled “SYSTEM AND METHOD FOR CONFIGURING A ROUTER” filed May 23, 2006, U.S. Ser. No. 11/438,848 titled “SYSTEM AND METHOD FOR CREATING APPLICATION GROUPS” filed May 23, 2006, and U.S. Ser. No 11/438,761 titled “SYSTEM AND METHOD FOR MODIFYING ROUTER FIRMWARE ” filed May 23, 2006 are herein incorporated by reference in their entireties.

Any-to-any syntax and/or semantics conversion is generally a process for converting commands, instructions or information from any existing or future developed first syntax and/or semantics to any other existing or future developed second syntax and/or semantics. Commands, instructions or information are generally directions embedded into a database or computer program that result in an operation being performed. Commands, as used in the present application, maybe various instructions embedded into a computer program for network device configuration. Commands may also be any other types of commands, instructions or information relevant to the process being performed. Most manufacturers use distinct, proprietary syntaxes and/or semantics to program devices created by that manufacturer. New syntaxes and/or semantics are continuously being created to run new devices. Most network devices also have different semantic requirements for providing models of network device actions. Conversion is needed whenever an input syntax and/or semantics are different than an end syntax and/or semantics or where different devices require different semantic protocols. A converter is needed to convert the commands, instructions or information from a user selected first syntax and/or semantics into a second syntax and/or semantics that will be understandable to the target network device. Conversion allows transfer of commands, instructions or information from one syntax and/or semantics to another syntax and/or semantics and back again without losing the meaning of the commands, instructions or information. For example, a NORTEL syntax may be used to program a CISCO device, or a CISCO syntax may be used to program a NORTEL device. Alternatively, a NORTEL semantic from a NORTEL device maybe used to program a CISCO device with capabilities distinct from the NORTEL device, or a CISCO semantic from a CISCO device may be used to program a NORTEL device with capabilities distinct from the CISCO device.

In addition to any-to-any syntax and/or semantic converters, embodiments of the present invention may also include many-to-many, one-to-many and one-to-one syntax and/or semantic converters. Many-to-many syntax and/or semantic converters convert from a finite set of syntaxes and/or semantics to another finite set of syntaxes and/or semantics. One-to-many syntax and/or semantic converters convert from a first selected syntax and/or semantics to a finite set of syntaxes and/or semantics. One-to-one syntax and/or semantic converters convert from a first selected syntax and/or semantics to a second syntax and/or semantics. Embodiments of the present invention may cover the broadest conversion, any-to-any, or may cover more limited syntax and/or semantic conversions.

Embodiments of the present invention may include a converter, also known as a confabulator, for any-to-any, many-to-many, one-to-many, and one-to-one syntax and/or semantics conversion back and forth between an input module and a network device. The converter abstracts network devices away from manufacturer specific syntax and/or semantic capabilities by making the network devices configuration independent through syntax and/or semantic conversion. An application program interface of the present invention preferably converts between input modules and output modules. Commands, instructions or information are entered into an input module by a user and converted into a syntax and/or semantics understandable by an end device. The converted commands, instructions or information are sent to an output module before being sent to an end device. The converter can allow the user to choose from any input module to program network devices.

FIG. 1 is a schematic overview of an embodiment of a network system shown generally at 1 in accordance with the principles of the invention. As shown, a server 3 is preferably connected to a network 5. The network 5 may include WAN, LAN, the Internet, direct connections or other similar configurations. The server 3 may or may not be part of the network 5 depending on the needs and setup of individual systems. The server 3 maybe a traditional server as found in business to business applications, or may be individual hard drives. The server 3 may contain a processor 4 and a memory 6. The memory 6 may further contain an internal database 8 as described below. A network device 7 may also be connected to the network 5. Network devices 7 may include routers, modems, switches and other devices connected to the network for the purpose of mediating data in a computer network. A syntax and/or semantic converter, specifically an application program interface (API) converter, according to the principles of the invention is shown generally by reference numeral 9. As illustrated, the converter 9 can be located at server 3 and/or at network device 7. Other locations, including remote locations other than the server 3 or network device 7 are contemplated in accordance with the principles of the present invention.

The converter 9 of the present invention can be used to configure network devices 7. Configuration of new or altered network devices 7 may be required when network devices 7 are replaced or altered. In some instances, an old network device will be replaced with a new network device that operates with a different standard syntax and/or semantics than the previous network device. The converter 9 may be used to communicate with devices from different manufacturers or devices using different syntaxes, semantics or other programming requirements.

The user may initiate a discovery process to identify any new or altered devices 7 on the network 5. Alternatively, new or altered devices 7 may initiate a configuration process or cause a discovery process to be run on a server. The discovery process may be manual or automatic depending on the system. The discovery process is preferably a broad process that detects syntaxes, semantics, and any other relevant information.

The steps of the present invention maybe performed in various orders depending on specific circumstances and situations. For example, the first step in a conversion process is preferably to identify a target network device 7. After identifying the target network device 7, the converter 9 may be loaded. Alternatively, the converter 9 may be loaded first and then target network devices 7 may be identified. Other and various orders of steps are contemplated by embodiments of the present invention.

Regardless of when the identification of target network devices 7 and loading of the converter 9 occur, the discovery process and associated capabilities assessment may determine what network devices 7 are currently located on the network A capabilities assessment may be performed during the discovery process. A user may program a network device 7 on the network 5 using a third party command line process, a graphical user interface, or other similar process. However, if the user tried to enter a command, in a command line process, which is not supported by the network device 7, the user would get a warning message indicating command is not supported. As an example, if the user were trying to send an MPLS command to a network device 7 that does not support GALS, the user would get a warning. Similarly in a graphical user interface programming option, the command would not be available or grayed out in the menu indicating that the network device 7 does not support the command.

The converter 9 of the present invention preferably does not merely convert syntactically, but is able to convert semantically. The converter 9 preferably determines that when a route is set on a router, the user is attempting to specify the path that packets will take across the device. Subsequently, if a user wants to convert the route setting command onto a switch, which has no concept of routing, the converter 9 does not fail based on the fact that switches do not have route setting commands. Instead, the converter 9 may convert the route setting commands into commands that exist on the switch and may allow the user to determine how packets will move across the device. Thus, the capabilities assessment allows and the discovery process can allow a user to convert semantically in addition to syntactically.

The converter 9 may be accessed in a variety of ways in accordance with the principles of the invention. The converter 9 may be initiated automatically or at the direction of a user or by a command. For example, the converter functionality may be initiated through a point and click option in a graphical user interface or through a command line interface or through any other interfaces that exist or maybe developed. In this example, a user may use a mouse or other input device to point and click on an option shown on a computer monitor. Alternatively, the user may type a command line into a prompt that maybe presented to a user.

Once the converter 9 has been initiated, an output module 13 must be generated so that commands, instructions or information may be transferred to a network device 7. The present invention may allow for the choice of output module 13 based on specific end network devices 7. An output module 13 maybe a method defined by the manufacturer that is used to send batch configuration to the device, i.e. TCP control socket, TFIP, etc. The output module 13 is preferably chosen to correspond to the syntax and/or semantics of the network device 7 as determined during the discovery process.

The converter 9 may be found on a network device 7 or a server 3. If the converter 9 functions on a network device 7, the network device 7 is preferably able to accept command lines. As an alternative to command line operations, a graphical user interface may be provided to create a command line for the network device 7. The converter 9 may be built into firmware on the network device 7. Conversion may then take place in the firmware on the network device 7 instead of at a remote location. For example, a command-line interface on a network device 7 may accept commands input in any language, even without a standard graphical user interface. If the converter is run on a server 3, any equipment may be connected to the network 5. If the converter 9 is run on the server 3, while the converter 9 is not located on the network device 7, converted configuration files may reside on the network device 7.

Preferably, a standard graphical user interface or a point and click graphical user interface may be used to program any manufacturer's device 7 in the native syntax and/or semantics of the manufacturer's device 7. However, any other input modules 11 may be used. A graphical user interface may allow the user to open a command line interface in the graphical user interface to program any manufacturer's device 7 in the native syntax and/or semantics of the manufacturer's device 7. For example, a NORTEL command line interface could program a CISCO device. Alternatively, any native command line interface from an input module 11 may be used to program any manufacturer's network device 7 in the native syntax and/or semantics of the manufacturer's device 7 based on the chosen output module 13.

FIG. 2 shows a schematic of input options 11 and output options 13 passed through an application program interface converter 9. The converter 9 of the present invention preferably allows input in any manufacturer's standard syntax and/or semantics. The converter 9 can preferably convert any-to-any syntax and/or semantics, and may support any-to-any conversion of existing or future manufacturer's syntaxes and semantics. The converter 9 may support many-to-many, one-to-many or one-to-one syntax and/or semantic conversions. Many-to-many conversion contemplates a finite number of syntaxes and/or semantics for conversion. However, new syntaxes and/or semantics may also be supported in accordance with the principles of the invention. As new syntaxes and/or semantics are developed, the converter 9 is adapted to allow conversion of the new syntax and/or semantics back and forth into existing syntaxes and/or semantics.

The input options 11 may create and provide input in the form of modular commands, instructions or information if the manufacturer's syntax and/or semantics only accept modular commands, instructions or information. The modular commands are discrete units that are sent to the network device 7 for specific purposes. The input options 11 may include, but are not limited to, a graphical user interface to manage devices 17, CISCO IOS syntax command line input 19, JUNIPER syntax command line input 21, NORTEL syntax command line input 23, ALCATEL syntax command line input 25, or any other syntax input 27. The output options 13 may also be modular based on a manufacturer's syntax. The output options 13 may be, but not limited to, NETCELLERATOR syntax 29, CISCO IOS syntax 31, JUNIPER syntax 33, NORTEL syntax 35, ALCATEL syntax 37, or any other syntax 39.

The converter 9 may convert between any input formats in accordance with the principles of the invention. For example, the converter 9 may operate at a command or a configuration level. Other types of input formats are possible and anticipated by embodiments of the present invention. The command level may involve conversion of commands, instructions or information received in a first syntax and/or semantic from a user into commands, instructions or information in a different syntax and/or semantic used by a network device 7. Tile configuration level may involve conversion of configurations stored within an internal database 8 from a first syntax and/or semantic into a different syntax and/or semantic used by a network device 7.

Therefore, the converter 9 may convert from commands, instructions or information in one syntax and/or semantic to commands, instructions or information in another syntax and/or semantic, as well as convert from configuration states stored in an internal database 8 in one syntax and/or semantic into a set of commands, instructions or information used to achieve that configuration state. Configuration states maybe stored in the internal database 8 as a result of an initial configuration of an initial network device 7 in an initial syntax and/or semantic. The configuration state may be accessed at a future time to configure a new network device 7. However, the new network device 7 may use a different syntax and/or semantic. The converter 9 is needed to convert the configuration state into a set of commands, instructions or information understandable to the new network device 7.

As stated previously, the converter 9 may operate at a command or a configuration level. In a first type format of input option commands, instructions or information maybe converted into an internal representation of a target configuration state. For example, a user may present a command:

ip route 1.2.3.4/32 2.3.4.5

On a CISCO network device 7, the above command may set a route for packets headed to an individual computer at 1.2.3.4 to pass through the network device 7 at 2.3.4.5. The first type of input format may convert the above command into an internal representation of “the device has a route for 1.2.3.4 with netmask 255.255.255.255 that sends that traffic through 2.3.4.5.”

In a second type of input format representations of configuration states may be converted into an internal representation of a target configuration state. For example, an automated network discovery feature can seek out and query network devices 7 for corresponding network device configurations. When the automated network discovery feature locates one or more network devices 7, the automated network discovery feature may query the one or more network devices 7. The one or more network devices 7 can send responses to the query back to the automated network discovery feature.

By using the automated network discovery feature, the converter 9 can identify a proper syntax and/or semantic to query the one or more network devices 7 before the converter 9 connects to the one or more network devices 7 to query configurations. After identifying the proper syntax and/or semantic, the converter 9 may then query the one or more network devices 7 regarding configurations. For example, the following command may be issued to a CISCO network device 7:

ip show interface

The CISCO network device 7 may respond with information about the interface. The information may be sent back to the converter 9. The converter 9 may take the information and place the information into an input module 11 related to the converter 9. The converter 9 can return an internal representation of the configuration state.

Therefore, regardless of the type of input module 11 used, i.e. whether converting from commands or from a table of output from a network device 7, the input modules 11 related to the converter 9 can return an internal representation of a target network device 7 configuration.

Use of the resultant internal representation is determined by specific situations. The converter 9 may choose to take the output from the input module 11 and place the output into an internal database 8 for future use. Alternatively, the converter 9 may choose to place the output from the input module 11 directly into an output module 13, bypassing the internal database 8.

The input options 11 of the present invention can allow a user to input modular commands in a user selected syntax and/or semantics. The modular commands may be fed into an internal database within the converter 9. The converter 9 of the present invention preferably converts from the internal database. Conversions preferably all pass through the internal database. However, the conversions may eliminate reliance on an internal database in the case of immediate conversions that may not be needed in the future. Conversion generally occurs in two stages: (1) from the input module 11 into the database, and (2) from the database to the output module 13.

Commands, instructions or information may be entered into the input module 11 by a user. The commands, instructions or information in the input module 11 can be parsed and tokenized by the converter 9. The parsed and tokenized information can be transferred from the input module 11 to the internal database. The internal database can sort and store the parsed and tokenized information in an intermediate syntax and/or semantic that mayor may not be a syntax and/or semantic corresponding to the syntax and/or semantic of the input module 11 or target network device 7. Preferably, a unique, third syntax and/or semantic can be used. The parsed and tokenized information in the internal database is preferably stored to allow efficient access to the information during operation of the converter. Preferably, when the information stored in the internal database is required for placing into an output module 13, only the appropriate parsed and tokenized information in the syntax and/or semantic of the internal database is accessed by the converter 9. The accessed information can be exported from the internal database, and can be placed into the output module 13 in a format that creates commands, instructions or information in a manufacturer specific syntax and/or semantic. The stored information preferably is not destroyed or deleted, but continues to be stored in the internal database for future reference.

The output module 13 can receive input from the converter 9. The converter 9 may be located on either the network device 7 or the server 3. The converter 9 selects output modules 13 based upon the target network device 7. The converter 9 identifies the manufacturer's syntax and/or semantics for a target network device 7 and loads a corresponding output module 13. Depending on the output module 13 chosen by the converter 9, appropriate commands, instructions or information from an input module 11 or internal database 8 are inserted into corresponding locations in the output module 13 and sent to the network device 7.

For example, if the converter 9 determines that an internal representation of the target network device 7 configuration state shows that the target network device 7 should have a “route”, then the converter 9 places commands, instructions or information relevant to an “add a route” function in corresponding locations in an output module 13. To continue the example, the following command maybe placed in an output module 13 and sent to a target network device 7 in a syntax and/or semantic understandable by the target network device 7 in response to a need for a “route”:

add_route(1.2.3.4, 255.255.255.255, 2.3.4.5, whateverElse).

The following is a simplified example demonstrating the operation of the converter 9 and an internal database of the converter 9. The simplified example demonstrates a two syntax and/or semantic system, but systems with larger sets of syntaxes and/or semantics are anticipated and preferred by embodiments of the present invention.

For this example, there may be two input modules 11 in existence (e.g., CISCO IOS and NET-CONEX) and two output modules (e.g., NET-CONEX and CISCO). Thus, in this simplified example, the converter 9 preferably knows how to take a CISCO commands and output the CISCO commands as NET-CONEX commands, and how to take NET-CONEX commands and output the NET-CONEX commands as CISCO commands.

A user may desire to input a command. For example, a command may be input to set a route of a network device to send any packets sent to a particular internet protocol address. Specifically, the user may enter an internet protocol address user by typing “ip route 1.2.3.4/32 2.3.4.5”. The typed command may be nonsense in NET-CONEX syntax. In contrast, in a CISCO syntax the typed command may be an effective command to set a route on the router to send any packets sent to the internet protocol address 1.2.3.4 to the device identified by IP address 2.3.4.5.

The converter 9 can analyze the typed command and decide that the typed command appears to be a CISCO command, and may load a CISCO input module 11. The CISCO input module 11 would tokenize the typed command based on CISCO syntax, and convert the typed command based on a CISCO dictionary.

The following is an exemplary representation of the conversion. Using $______ to represent a variable called ‘______’, the syntax may include a statement like:

ip route $from/$decimalNetmask $to

The dictionary may include a statement like:

“ip route $from/$decimalNetmask $to”=add_route($from, $dottedQuadNetmask $to, $additionalParameters)

Based on this, the input module may convert the typed command into the internal command:

add_route(1.2.3.4, 255.255.255.255, 2.3.4.5, DEVICE=null.

Each output module 13 may present an API 9. Thus, each output module 13 has the same interface. Regardless of the output module 13 triggering the command “add_route( )” in an output module 13 preferably results in an output module 13 in whatever command is appropriate in the target syntax and/or semantic in order to add the described route.

In the above example, if a CISCO output module 13 were attached, then the output of the command “add_route(1.2.3.4, 255.255.255.255,2.3.4.5, DEVICE=null)” would be “ip route 1.2.3.4/32 2.3.4.5”. If a NET-CONEX output module 13 were attached, then the output of the command “add_route(1.2.3.4, 255.255.255.255,2.3.4.5, DEVICE=null” would instead be “ip route add 1.2.3.4/32 via 2.3.4.5”.

Preferred embodiments of the present invention may also include has a dictionary conversion from an internal database. In the above example, instead of converting directly from “ip route ______” to “add_route(______)”, the data in the typed command maybe first stored in the internal database. The internal database is preferably a set of structured data stored in tables in a relational database management system (RDBMS) on a server. An RDBMS is a subtype of database management system (DBMS) that stores data in the form of related tables. An RDBMS requires few assumptions about how data is related or how it will be extracted from the database, and allows the database to be viewed in various ways. Then the data from the typed command may be lifted out of the internal database and pushed into the API command, in this example, “add_route( )”.

The internal database provides the converter 9 with the ability to input and output at different times, and more than once for the same input. For example, the typed command can be input in anticipation of a particular network device 7 being hooked to the network 5. When the network device 7 is added to the network 5, the converter 9 preferably finds the desired configuration represented in the internal database. The converter 9 may then attach the appropriate output module 13 and output the appropriate commands. Subsequently, if the network device 7 were changed, then the converter 9 may simply attach a new appropriate output module 13 and feed the commands to the new network device 7. For example, the old network device 7 may be disconnected and replaced with a new network device from a different manufacturer.

Preferably, the converter 9 stores network device 7 configuration commands, instructions, and information as an abstract in the internal database 8. However, it is not required that the network device 7 configuration commands, instructions, and information be stored in the internal database 8. If the internal database 8 is used, the commands, instructions and information stored in the internal database 8 may include actions and capabilities of the network device 7. Storage of the commands, instructions and information in the internal database 8 may allow for replacement of a first network device 7 with a different network device 7 with different capabilities. Replacement of the first network device 7 with a different network device 7 with different capabilities may require a conversion process. Conversion is facilitated through storage of commands, instructions and information in the internal database 8. By storing commands, instructions and information in the internal database 8, the commands, instructions or information may be applied to the different network device 7 despite differences in syntax and/or semantics. The converter 9 may program the different network device 7 according to requirements stored in the internal database 8 that were used to program the first network device 7 despite differences in syntax and/or semantics.

If the different network device 7 has capabilities not present in the first network device 7, the converter 9 preferably only changes a configuration based on capabilities present in the first network device 7. The converter 9 preferably does not change configurations based on capabilities not present in the first network device 7. Capabilities not present in the first network device 7 are preferably only changed by new input from the user of the different network device 7. For example, if the different network device 7 is capable of multiprotocol label switching (MPLS) and the first network device 7 was not capable of MPLS, the converter 9 preferably only uses the features of MPLS if requested by the user managing the system. The converter 9 preferably does not start using capabilities not found in the first network device 7 without explicit instructions from the user to use the capabilities not found in the first network device. Instructions from a user related to capabilities not found in the first network device 7 may then be stored in the internal database 8 for use with other network devices. However, the converter 9 may understand the difference between a router function versus a virtual local area network (VLAN) function and program the network device 7 accordingly.

The internal database 8 can allow the converter 9 to become an any-to-any converter. By using the internal database 8, the converter is not limited to a one-to-one conversion, but may function as a one-to-many and any-to-any converter. The internal database 8 may store information for the duration of time needed by a user or longer. The internal database 8 may be discarded after a first set of configurations or alterations or may be stored for use in future configurations or alterations.

Any of the conversions from the internal syntax and/or semantics to an output syntax and/or semantics may happen at any time after the initial input conversion. This may include conversions that take place immediately after the initial input conversion or months or longer after the initial input conversion. The input commands, instructions and information maybe stored in the internal database and maybe accessed by the converted when needed.

For example, the converter 9 is not limited to a one-to-one conversion, such as by converting from a CISCO syntax and/or semantics to an internal syntax and/or semantics and then from the internal syntax and/or semantics to a NORTEL syntax and/or semantics. The converter 9 is an any-to-any, many-to-many, one-to-many, or one-to-one converter where the converter 9 may access the internal database and convert from a CISCO syntax and/or semantics to an internal syntax and/or semantics and then from the internal syntax and/or semantics to a NORTEL syntax and/or semantics, or from the internal syntax and/or semantics to an ALCATEL syntax and/or semantics, etc.

The database may allow the converter 9 of the present invention to abstract a network device 7 away from a make or model and into a role by making the configuration of the network device 7 device-independent. For example, edge routing on a network 5 may be handled by a CISCO router. The network administrator may want to use the CISCO router elsewhere on the network 5 and the network administrator has a spare NORTEL switch. The network administrator may take the CISCO router off the network and plug the NORTEL switch in place of the CISCO router. The converter 9 is instructed to manage the change of network devices 7. This converter 9 may detect the capabilities of the NORTEL switch, identify its manufacturer, and then configure the NORTEL switch to behave like the CISCO router. This can be true even though the switch is not a router, and cannot perform all functions of a router.

In addition to converting from one manufacturer's syntax and/or semantics to another, the API converter 9 of the present invention may also be used to program different devices from the same manufacturer with disparate configuration requirements. For example, if an older CISCO router is substituted for a newer CISCO router, the converter 9 may recognize the different abilities and requirements of the devices. For example, if the older device has less functionality than the newer device, the converter 9 alters the commands to remove higher level functionality. The higher level functionality may be stored in a database should another device be substituted that can operate with the higher functionality, if a newer CISCO router is substituted for an older CISCO router, the converter 9 may recognize the higher functionality and alter the configuration process to take advantage of the new functionality.

Now, reference will be made to FIGS. 3-6 to discuss preferred methods in accordance with the principles of the invention. FIG. 3 shows an overview flow diagram of an embodiment of the present invention. FIG. 4 shows a flow diagram of an embodiment of a configuration client's request for a current configuration of a target device. FIG. 5 shows a flow diagram of an embodiment of the configuration client using the converter application program interface to generate a converter's internal model of a configuration state. FIG. 6 shows a flow diagram of an embodiment for sending manufacture specific syntax and/or semantics to the target device to allow configuration of the target device.

As shown in FIG. 3, a configuration client may initially request 41 the status of a target device 7. A configuration client is a program software that provides user-interactivity between a user and an end device for the purpose of generating a configuration state for any particular device. A configuration state is a set of different configuration commands used to set any particular device to a particular state. Servers and command line interfaces are examples of configuration clients. Other configuration clients are possible. With graphical user interface servers, browser forms can be used to initialize device settings. The servers can store settings into a database. With command line interfaces, a client can read user commands from a read line-like interface. The configuration client can keep an in-memory buffer of all commands received.

The configuration client may receive the status 43 of the target device 7 after an initial request. The configuration client may load 45 a converter 9. The converter 9 preferably generates 47 an output module 13 appropriate for the target device 7 based on data from the configuration client. The converter 9 may iteratively receive input 49 about the device status from the configuration client. The converter 9 then can arrange the input 51 from the configuration client into the output module 13. The converter 9 may send 53 the output module 13 to the target device 7. The target device 7 may then use the output module 13 for configuration 55.

The configuration client preferably can generate an internal model of the configuration state of a target device. There are multiple methods that the configuration client may use to generate the internal model of the configuration state of the target device 7. First, this internal model may be persistent or not depending on how the configuration client is implemented. Second, the configuration client may request the current configuration state of a target device through a converter 9 to initialize a configuration state of the configuration client. Other methods for generating an internal model of the configuration state of the target device 7 are contemplated by the methods of the present invention.

FIG. 4 shows a flow diagram of a configuration client's request for a current configuration of a target device according to the second method of generating the internal model of the configuration state of the target device 7. Generally, a user interface can be provided for generating or changing a configuration.

A converter 9 is initiated in accordance with the principles of the invention to load 57 an input module 11 that corresponds to a target device 7. The converter 9 may be initiated at the request of a user or automatically upon addition of a network device 7 to a network 5. An input module 11 may be selected by a user or automatically selected. The input module 11 is chosen based upon the preference of the user. The user preferably chooses an input module 11 with which the user is knowledgeable to ensure accurate and clear communication between the converter 9 and the target device 7 as the user enters commands for the target device 7.

With the communication link established between the converter 9 and the target device 7, the converter 9 can then use manufacturer specific syntax and/or semantics of the target device 7 to request information 59 about the internal configuration state of the target device 7. Manufacturer specific syntax and/or semantics are the symbols and syntax and/or semantics defined by a manufacturer and used to configure a device 7. The internal configuration state of the target device 7 is a description of the current configuration status of the target device 7. For example, the target device 7 can be queried in the manufacturer specific syntax and/or semantics of the target device 7 to supply the converter 9 with information needed by the converter 9 to send commands, instructions or information. These commands, instructions or information may include show interface, show network devices, etc.

The converter 9 can then receive 61 the requested information from the target device 7 in the manufacturer syntax and/or semantics of the target device 7. Necessary information from the network device 7 may vary from device to device depending on the configuration requirements. The converter 9 can generate information that can be used by the configuration client to initialize an internal configuration state. For example, the converter 9 can generate an XML or other similar document from the information sent by the target device 63. The XML or other similar document can describe the internal configuration state of the target device 7. The XML or other similar documents can be parsed by the configuration client. The XML or other similar definitions can be used by the configuration client to initialize an internal configuration state.

FIG. 5 shows a flow diagram of the configuration client using the converter application program interface 9 to generate a converter's internal model of configuration state.

As shown above, the configuration client preferably can generate the configuration client's internal model of the configuration state of a target device where: (1) the state maybe persistent or not, or (2) the configuration client may request the current configuration state of a target device 7 through a converter 9 to initialize a configuration state of the configuration client. The configuration client may use one of these methods, or other similar methods, to generate the configuration client's internal model of the configuration state of a target device.

After generating the configuration client's internal model of the configuration state of the target device, the configuration client can use the converter application program interface 9 to generate a converter internal model of configuration state. The converter internal model of the configuration state is separate from the configuration client's internal model of the configuration client and describes the internal configuration of the target device 7 in a user selected syntax and/or semantics.

The configuration client can load 65 the converter 9. The configuration client calls the converter 9 and initiates the converter 9 program sequence. The configuration client can then determine 67 the type of device 7 for which the configuration will be performed.Device types may be determined by requesting information from a target device 7 or the target device 7 may send the information without a request or prompt. The device type is preferably sent 69 to the converter 9. The converter can load 71 a correct output module for the device type. The configuration client may then iterate 73 over the internal state of the configuration client, calling for each piece of information needed to generate the converter model of the internal state of the target device as the information is required. The configuration client can call the converter application program interface 9 for each piece of configuration information needed until the converter model of the internal state of the target device 7 is completed. After all information has been iteratively sent, the converter model of the internal state of the target device 7 is arranged and finalized.

The following is an example of pseudo-code for calling the converter program interface 9 and iteratively sending information required by the configuration client for developing a model of the internal state of the target device 7:

```
    function generate_ConfabulatorState(string $device_type,
    array $internalConfig)
      {
        $confab = new Confabulator($device_type);
        foreach($internalConfig as $config) {
          if ($config->type == “ip address”) {
            $confab->set_ip_address($config->interface,
$config->address, $config->netmask);
          }
          else if ($config->type == “route”) {
            $confab->set_ip_route($config->host,
            $config->gateway);
          }
          ...
        }
      }
```

FIG. 6 shows a flow diagram for sending manufacture specific syntax and/or semantics to the target device 7 to allow configuration of the target device 7. The converter 9 preferably iterates 75 over the internal configuration state as discussed in reference to FIG. 5. During the iteration, the converter 9 may generate 77 manufacturer specific syntax and/or semantics for each piece of the internal configuration state. The converter 9 can then load 79 a transport module. The transport module is preferably formatted to the specifications of the target device 7 as determined during the discovery process, with commands and syntax and/or semantics understandable by the target device 7. The converter 9 can then send 81 the manufacturer specific syntax and/or semantics for the target device 7, generated for the transport module, to the target device 7. The transport module in the manufacturer specific syntax and/or semantics is preferably sent en-batch, but maybe sent in smaller pieces if necessary for efficient operation of the system.

The target device 7 can receive 83 the manufacturer specific syntax and/or semantics in the output module 13 from the converter 9. The target device 7 can parse the manufacturer specific syntax and/or semantics to set 85 an internal configuration state. The target device 7 can use internal manufacturer supplied routines for configuration. The routines are preferably already contained within the target device 7, and the routines preferably accept the commands, instructions or information contained in the transport module.

Configuration of a network device 7 is then preferably completed when routines supplied to the network device 7 from the converter 9 are finished running. A check may be performed by the user to ensure proper configuration of the target device 7.

In another preferred embodiment, the converter 9 operates by receiving a command from an input module 11 located at a configuration client. The command is preferably formatted in a syntax and/or semantic associated with the input module 11 and maybe different from the syntax and/or semantic associated with an end device The converter 9 preferably recognizes and identifies the syntax and/or semantic associated with the command and the input module 11. The command can then be tokenized and parsed. The meaning of each command can be determined. Commands are preferably tokenized and the tokens are categorized according to the content of the commands.

The database may store the parsed and tokenized commands for faster and more efficient lookup of system information. The database stores information on all network devices 7 connected to the server 3 over a network 5.

The tokenized information can be feed into a database on a server 3 or at another location by the configuration client. The database may be a configuration server or other similar server. The tokenized information can be sorted into a table in the database. The database preferably does not contain commands, but is a database or routing table that contains information taken from commands but not the complete commands. The database may contain columns for definitions, origination, physical port numbers, logical port numbers, priority, and other information.

During operation of the converter and programming of a target device 7, commands, instructions or information can be sent to an end device 7 by the converter 9. The converter 9 can obtain the necessary information from the database and place the information into an appropriate location within the output module 13. The output module 13 can be formatted in the syntax and/or semantics of the target device 7. The output module 13 can be sent and downloaded by the target device 7.

In another preferred embodiment of the present invention, the converter 9 may include a concrete application program interface 9 for creating an output module system 13 useable by a target device 7. The concrete application program interface 9 can describe actions that can be done on a router or other similar device in a syntax and/or semantics understandable by the target device 7. The configurable program interface (CPI) 9 can define all the configuration options that could be executed on any target device 7. If implemented as an abstract base class, the CPI 9 may merely define what actions must be implemented by the output modules 13 to provide the conversion functionality.

The following is an example of a CPI interface 9:

```
namespace Confabulator
{
  class CPI {
    virtual void add_ip_address(string interface, string ip_addr, string
    mask) = 0;
    virtual void del_ip_address(string interface, string ip_addr, string
    mask) = 0;
    virtual void show_ip_address(string interface) = 0;
    virtual void has_ip_address(void) { return true; }
    virtual void add_route(string network, string gateway) = 0;
    virtual void del_route(string network, string gateway) = 0;
    virtual void has_route(void) { return true; }
  }
}
```

In alternative embodiments, certain functionalities in the converter 9 can be implemented to allow for different feature sets and verification. For example, an older network device may not have all virtual private network functionalities contained by more modem systems and devices. The feature sets of a newer network device may be uncovered in a discovery process and the higher functionality may be included in the configuration process to allow utilization of the higher functionality. The different features set information maybe stored in a database for reference during future configuration and alterations. Different verification processes may also be accommodated. Older network devices may have different verification procedures or require different commands, instructions or information. These requirements may be anticipated by the converter 9 and the configuration process may be altered accordingly. Differences in feature sets and verification are reflected in the output modules 13 generated by the converter 9. Each output module 13 is specific to the target device 7 and manufacturer syntax and/or semantics of the target device 7. The output modules 13 preferably provide a mechanism to translate commands in the CPI namespace into a device specific configuration syntax and/or semantics.

The following is an example of an output module 13 implementation for sending commands, instructions and information to a target device 7. Generally, the output module 13 contains information needed for configuration or alteration of the internal status of the target device 7. The output module 13 sends this information in the syntax and/or semantics understood by the target device 7.

```
namespace Confabulator
{
  class IOS_Output : public CPI
  {
    void add_ip_address(string interface, string ip_addr, string mask);
    void del_ip_address(string interface, string ip_addr, string mask);
  }
  void IOS_Output::commands() {
    CPI_Command &cmd = add_command(“interface %0”, CPI_STRING);
    cmd.add_terminator(“!”);
  }
  void IOS_Output::add_ip_address(string interface, string ip_addr, string mask) {
    require_command(“interface %0”, interface);
    addto_buffer(“ip address %0/%1”, ip_addr, this->format_mask(mask));
  }
  void IOS_Output::del_ip_address(string interface, string ip_addr, string mask) {
    require_command(“interface %0”, interface);
    addto_buffer(“no ip address %0/%1”, ip_addr, this->format-mask(mask));
  }
  void IOS_Output::add_route(string network, string gateway) {
    addto_buffer(“ip route %0 %1”, network, gateway);
  }
  void IOS_Output::has vpn(void) {
    return false;
  }
}
```

The following is an example workflow as produced by a converter 9. In the example, a configuration file was compiled with a top-level interface. The top-level interface then uses the CPI 9 to send its current configuration state out to the target device 7. The configuration state contains information on the interface and route. This information maybe stored in a database. The CPI 9 then issues a command based on the information from the configuration state. The CPI commands are then combined into an output module 13 for sending to the target device 7. The output module 13 contains the information from the configuration state in a syntax and/or semantics understandable by the target device 7.

```
Configuration state
interface en1[
  IP:192.168.0.1
  MASK:255.255.255.0
]
route [
  NETWORK: 0.0.0.0
  GATEWAY: 192.168.0.1
]
CPI commands issued
add_ip_address(“en1”, “192.168.0.1”, “255.255.255.0”);
add_route(“0.0.0.0”, “192.168.0.1”);
  CPI + Output modules
IOS syntax output
interface en1
ip address 192.168.0.1/255.255.255.0
!
ip route 0.0.0.0 192.168.0.1
```

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention maybe used in conjunction with other embodiments, even if not explicitly stated above.

What is claimed is:

1. A method of managing network devices independent of native functionality comprising:
identifying a target network device,
loading a converter,
identifying a native functionality of the target network device,
receiving commands in an input module in a selected functionality,
parsing and tokenizing the commands,
generating an output module in the native functionality of the target network device,
outputting the relevant parsed and tokenized commands into the output module, and
sending the output module to the target network device for managing the target network device.

2. The method of claim 1, further comprising receiving input about the target network device from the target network device during the step of identifying native functionality of the target network device.

3. The method of claim 2, further comprising parsing and tokenizing the input about the target network device.

4. The method of claim 3, further comprising storing the parsed and tokenized input in a network device database.

5. The method of claim 1, wherein the intermediate functionality is distinct from the native functionality of the network device and the selected functionality.

6. The method of claim 1, further comprising outputting the stored commands to other output modules for other network devices in other native functionalities.

7. The method of claim 1, further comprising storing the parsed and tokenized commands in an internal database in an intermediate functionality and accessing relevant parsed and tokenized commands in the internal database.

8. The method of claim 7, wherein the internal database is a configuration server.

9. The method of claim 1, wherein the receiving commands is performed via a graphical user interface.

10. The method of claim 1, wherein the receiving commands is performed via a command line interface.

11. The method of claim 1, further comprising storing end user information on a server.

12. A method of managing a series of network devices independent of native functionality comprising:
identifying a target network device,
loading a converter,
identifying a native functionality of the target network device,
receiving input about the target network device from the target network device during the step of identifying native functionality of the target network device,
parsing and tokenizing the input about the target network device,
storing the parsed and tokenized information in a network device database in an intermediate functionality,
inputting commands into an input module in a selected functionality,
parsing and tokenizing the commands in the input module,
storing the parsed and tokenized commands in an internal database,
generating an output module in the native functionality of the target network device,
accessing relevant parsed and tokenized commands in the internal database,
outputting the relevant parsed and tokenized commands into the output module,
sending the output module to the target network device for managing the target network device, and
outputting the commands to other output modules for other network devices in other native functionalities.

13. A system of managing network devices independent of native functionality comprising:
means for identifying a target network device and native functionality of the target network device,
means for receiving commands in an input module in a selected functionality,
means for parsing and tokenizing the commands from the input module,
means for storing the parsed and tokenized commands in an internal database in an intermediate functionality,
means for generating an output module in the native functionality of the target network device,
means for accessing relevant stored commands in the internal database,
means for outputting the relevant commands from the internal database into the output module,
means for sending the output module to the target network device for configuring the target network device, and
means for outputting the commands in the internal database other output modules for other network devices in other native functionalities.

14. The system of claim 13, further comprising a means for receiving input about the target network device from the target network device.

15. The system of claim 14, further comprising parsing and tokenizing the input about the target network device.

16. The system of claim 15, further comprising storing the parsed and tokenized input in a network device database.

17. The system of claim 13, wherein the internal database is a configuration server.

18. The system of claim 13, wherein commands are received in an input module in the selected functionality via a graphical user interface.

19. The system of claim 13, wherein commands are received in an input module in the selected functionality via a command line interface.

20. The system of claim 13, further comprising storing end user information on a server.

21. An API converter comprising:
an identifier for identifying a target network device and native functionality of the target network device,
a receiver for receiving input about the target network device from the target network device,
an input module for receiving commands in a selected functionality,
a conversion protocol for converting the commands from the selected functionality to an intermediate functionality and then to the native functionality of the target network device,
one or more output modules for receiving the commands from the conversion protocol, and
a transmitter for transmitting the one or more output modules to one or more target network devices.

22. The API converter of claim 21, wherein the conversion protocol parses, tokenizes and stores the commands in the intermediate functionality in an internal database.

23. The API converter of claim 21, wherein input about the target network device is stored in a network device database.

24. The API converter of claim 21, wherein the API converter is located on a server connected to a network 25. The API converter of claim 21, wherein the API converter is located on the target network device connected to a network 26. A network device converter database comprising:
a first receiver for receiving commands from an input module in a native functionality of a first network device,
an identifier for identifying the native functionality of the commands from the input module,
a parser for parsing the commands into a selected functionality,
a tokenizer for tokenizing the commands into a selected functionality,
a storage device for storing the parsed and tokenized commands,
a second receiver for receiving requests for the stored commands, and
a transmitter for transmitting the stored commands to an output module in a native functionality of a second network device.
